(19) United States
(12) Patent Application Publication
(10) Pub. No.: US 2004/0043665 A1
(43) Pub. Date: Mar. 4, 2004

(54) Power adapter with freely rotatable direct current plug connection

(76) Inventor: Chen-Chun Chen, Taoyuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/065,343

(22) Filed: Oct. 7, 2002

(30) Foreign Application Priority Data
Aug. 27, 2002 (TW) 91119341

(51) Int. Cl. H01R 25/00

(52) U.S. Cl. 439/638

(57) ABSTRACT

A power adapter having a freely rotatable plug connection comprises a main body, a DC wire, and an AC wire. The main body includes a casing that respectively encloses an adapter circuit board, a DC connector port and an AC connector port, the DC connector port and the AC connector port being respectively arranged on the adapter circuit board. A terminal of the DC wire electrically connects a DC plug that mates with the DC connector port according to a freely rotatable manner, and another terminal of the DC wire electrically connects an output plug to deliver a signal to an electrical device. A terminal of the AC wire electrically connects the AC connector port and another terminal of the AC wire electrically connects another plug.

### CROSS REFERENCE TO RELATED APPLICATIONS

This application claims the priority benefit of Taiwan application serial no. 91119341, filed Aug. 27, 2002.

### BACKGROUND OF INVENTION

1. Field of the Invention

The invention relates generally to a power adapter that converts an alternating current (AC) to a direct current (DC). More particularly, the invention provides a power adapter having a freely rotatable DC plug connection that can relieve mechanical stresses produced in the DC wire when it is wound.

2. Description of the Related Art

FIG. 1A is a perspective view showing the connection conventionally achieved between a direct current (DC) wire and a DC terminal of a power adapter. As shown, a traditional power adapter 100 comprises a main body 102, a DC wire 104, and an alternating current (AC) wire 108. The main body 102 further includes a DC terminal 102a and an AC terminal 102b that, respectively, electrically connect the DC wire 104 and the AC wire 108.

Within the traditional power adapter 100, the electrical and mechanical connection between the main body 102 and the DC wire 104 is usually achieved via welding which therefore fixedly attaches the DC wire 104 to the main body 102. As a result, when the DC wire 104 is wound around the main body 102 for convenient arrangement, the definitive fixation between the DC wire 104 and the DC terminal 102a causes the generation of internal mechanical stresses at their corresponding connecting zone. To attenuate the effects caused by these mechanical stresses, a stress-buffer structure 106 may be provided at the connecting zone between the DC wire 104 and the DC terminal 102a.

FIG. 1B is a perspective view showing the traditional connection between the AC wire and the AC connector port within a power adapter. As shown, the casing 102 is further provided with an AC connector port 110 that is placed at the AC terminal 102b. The AC wire 108 directly engages by insertion in the AC connector port 110.

At some degree, the stress-buffer structure 106 may attenuate the mechanical stresses produced at the connecting zone between the DC wire 104 and the main body 102 during wire winding. However, this beneficial result is limited because the bending angle of the wound DC wire 104 is excessively high.

### SUMMARY OF INVENTION

An aspect of the invention is therefore to provide a power adapter having a freely rotatable DC plug connection that can relieve the mechanical stresses produced when the DC wire is wound around the power adapter.

To accomplish the above and other objectives, a power adapter having a freely rotatable plug connection comprises a main body, a DC wire, and an AC wire. The main body includes a casing that respectively encloses an adapter circuit board, a DC connector port and an AC connector port, the DC connector port and the AC connector port being respectively arranged on the adapter circuit board. A terminal of the DC wire electrically connects a DC plug that mates with the DC connector port according to a freely rotatable manner, and another terminal of the DC wire electrically connects an output plug to deliver a signal to an electrical device. A terminal of the AC wire electrically connects the AC connector port and another terminal of the AC wire electrically connects another plug.

In accordance with the above and other objectives, the casing is provided with an opening at a location corresponding to that of the DC connector port. The DC plug further includes an electrical connecting part mating with the DC connector port, and an insulating part partially covering the electrical connecting part. A slot is defined on the insulating part of the DC connector port to engage by fitting with a rim of the opening of the casing while allowing a free rotation of the DC plug relative to the casing.

In accordance with the above and other objectives, the insulating part of the DC connector port is further provided with a stress-buffer structure that relieves wire winding-induced mechanical stresses.

In accordance with the above and other objectives, the casing of the main body is further formed in an approximately parallelepiped shape that is provided with at least a recessed cavity. The recessed cavity receives the DC plug and a portion of the wound DC wire.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a perspective view showing the connection structure conventionally achieved between a direct current (DC) wire and a DC terminal of a power adapter;

FIG. 1B is a perspective view showing the connection structure conventionally achieved between an alternating current (AC) wire and an AC terminal of the power adapter;

FIG. 2 is a general perspective view of the external connection structure of a power adapter according to an embodiment of the invention;

FIG. 3 is an exploded view schematically illustrating the external connection structure of a power adapter according to an embodiment of the invention.

FIG. 4 is a schematic view schematically illustrating the placement of the DC plug within the power adapter according to an embodiment of the invention; and

FIG. 5A and FIG. 5B are perspective views schematically illustrating the external connection structure of a power adapter according to a second embodiment of the invention.

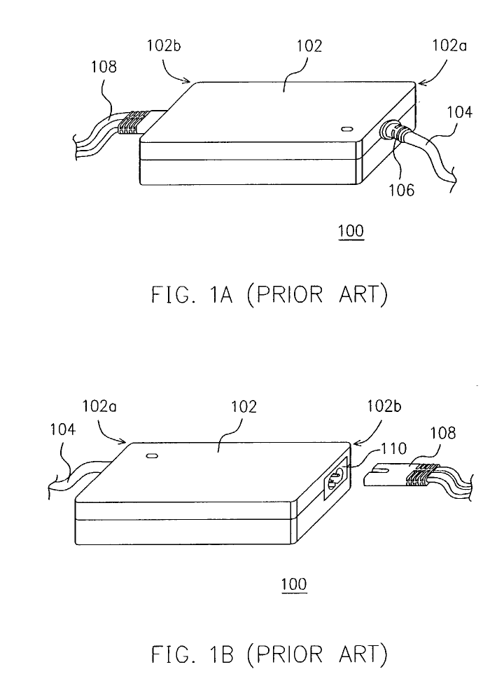

### DETAILED DESCRIPTION

The following detailed description of the embodiments and examples of the present invention with reference to the accompanying drawings is only illustrative and not limiting. Furthermore, wherever possible in the description, the same reference symbols will refer to similar elements and parts unless otherwise illustrated in the drawings.

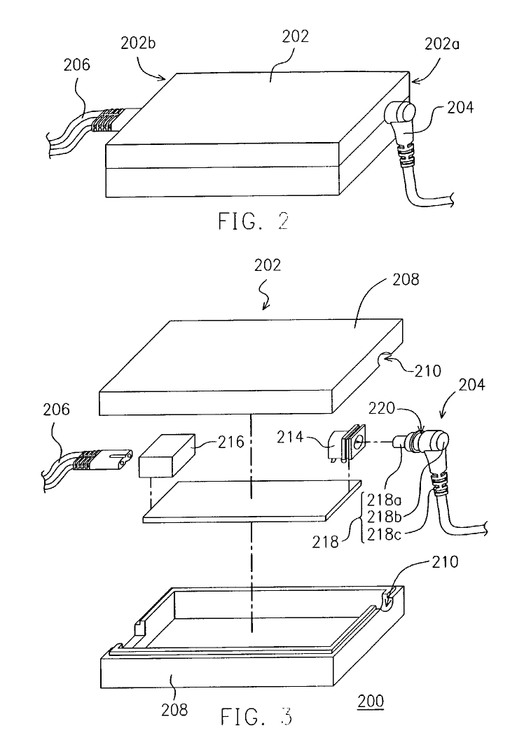

FIG. 2 is a general perspective view illustrating the external connection structure of a power adapter according to an embodiment of the invention. As shown, a power adapter 200 of the invention comprises a main body 202, a direct current (DC) wire 204 and an alternating current (AC) wire 206. The main body 202 includes a DC terminal 202a and an AC terminal 202b that, respectively, electrically connect the DC wire 204 and the AC wire 206. A major aspect of the invention is characterized in that the DC wire 204 connects the main body 202 according to a freely rotatable manner to relieve the mechanical stresses produced at the connecting zone between the DC wire 204 and the DC terminal 202a when the DC wire 204 is wound around the main body 202. The connection of the DC wire 204 to the DC terminal 202a is detailed hereafter.

FIG. 3 is an exploded view that schematically illustrates the external connection structure of a power adapter according to an embodiment of the invention. As shown, the main body 202 comprises a casing 208 that respectively encloses an adapter circuit board 212, a DC connector port 214 and an AC connector port 216. The DC connector port 214 and the AC connector port 216 are arranged on the adapter circuit board 212 to provide the necessary external connections of the power adapter. The casing 208 further includes an opening 210 corresponding to the location of the DC connector port 214.

A terminal of the DC wire 204 electrically connects a DC plug 218 that mates with the DC connector port 214 according to a freely rotatable manner by, for example, snap fitting. Another terminal of the DC wire 204 connects an output plug (not shown) to deliver a signal to an electrical device (not shown). Because the connection between the DC plug 218 and the DC connector port 214 is achieved via snap fitting and not welding as conventionally accomplished, the DC plug 218, once inserted in the DC connector port 214, is therefore capable of freely rotating relative to the latter. The DC connector port 214 is, for example, a jacket connector port.

The DC plug 218 comprises an electrical connecting part 218a, an insulating part 218b and a stress-buffer structure 218c. The electrical connecting part 218a mates with the DC connector port 214, and the insulating part 218b and the stress-buffer part 218c partially cover the electrical connecting part 218a. A slot 220 is further externally defined on the insulating part 218b. When the DC plug 218 is inserted in the DC connector port 214, a rim of the opening 210 of the casing 208 engages by fitting with the slot 220 of the insulating part 218a to prevent a separation of the DC plug 218 from the DC connector port 214 while allowing a relative rotation there between. Furthermore, the association of the stress-buffer structure 218c with the snap fit connection of the DC plug 218 substantially relieves wire winding-induced mechanical stresses such as wire torsions and/or internal tensions at the connecting zone between the DC plug 218 and the casing 202.

With respect to the AC terminal 202b of the power adapter 200, a terminal of the AC wire 206 electrically connects to the AC connector port 216 and another terminal of the AC wire 206 electrically connects to, for example, a plug (not shown).

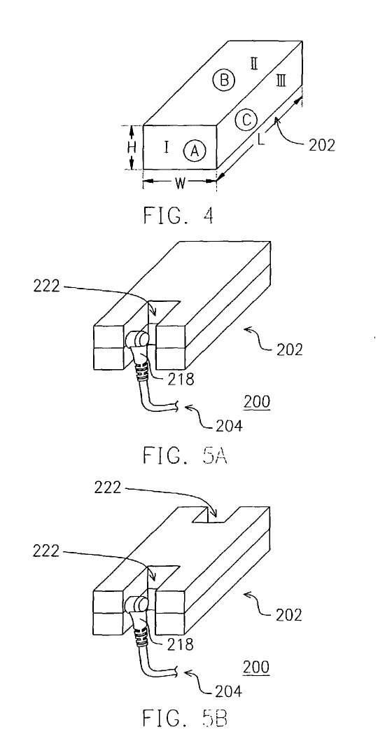

FIG. 4 is a schematic view illustrating the placement of the DC plug within the power adapter according to an embodiment of the invention. As shown, the reference symbols A, B, C represent different possible positions of the DC plug in the casing 202 shaped in a parallelepiped with a length L, a width W and a height H. The position A represents the conventional placement of the DC plug and is located on a planar surface I of the casing 202 defined by the directions (H, W). The position B is on a planar surface II defined by the directions (L, W). The position C is on a planar surface III defined by the directions (H, L).

The DC wire is conventionally wound around the casing 202 over the surfaces I, II. If the DC plug is placed at the position A, wire winding therefore causes a wire deformation that is close to the position A and, consequently, close to or on the stress-buffer structure. In contrast, if the DC plug is placed at either the locations B or C, the wire deformation is relatively farther from the DC plug and effectively occurs on the DC wire and not on the DC plug. As a result, the positions B and C are therefore the preferable positions of the DC plug to effectively prevent wire winding-induced mechanical stresses.

FIG. 5A and FIG. 5B are two perspective views showing the external connection structure of a power adapter according to a second embodiment of the invention. As shown in FIG. 5A, the casing 202 is in, for example, a parallelepiped shape provided with at least an approximately U-shaped recessed cavity 222. The recessed cavity 222 receives the DC plug 218 and, during wire winding, can further receive a portion of the wound DC wire 204, which increases the convenience of wire winding.

As shown in the variant example of FIG. 5B, two recessed cavities 222 may be oppositely formed through the casing 202 that, therefore, is formed in a general “H” shape. The DC plug 218 connects the power adapter in one of the recessed cavities 222 according to the above-described freely rotatable manner, and the DC wire 204 is wound around the casing 202 and partially received in the recessed cavities 222. The partial reception of the DC wire 204 in the recessed cavities 222 advantageously facilitates the winding operation.

As described above, the power adapter with a freely rotatable DC plug connection of the invention therefore includes at least the advantage of relieving mechanical stresses due to wire winding, which lengthens the service life of the DC plug. Moreover, the electrical and mechanical connection between the DC plug and the DC connector port is easily achieved via snap fitting.

It should be apparent to those skilled in the art that other structures that are obtained from various modifications and variations of different parts of the above-described structure of the invention would be possible without departing from the scope and spirit of the invention as illustrated herein. Therefore, the above description of embodiments and examples only illustrates specific ways of making and performing the invention that, consequently, should cover variations and modifications thereof, provided they fall within the inventive concepts as defined in the following claims.

1. A power adapter having a freely rotatable direct current (DC) plug connection, comprising:
a main body, including a casing that respectively encloses an adapter circuit board, a DC connector port and an alternating current (AC) connector port, the DC connector port and the AC connector port being respectively arranged on the adapter circuit board;
a DC wire, having a first terminal electrically connected to a DC plug that mates with the DC connector port according to a freely rotatable manner; and
an AC wire, having a second terminal electrically connected to the AC connector port.

2. The power adapter of claim 1, wherein the casing further includes an opening at a location corresponding to that of the DC connector port on the adapter circuit board.

3. The power adapter of claim 2, wherein the DC plug further comprises:
an electrical connecting part, mating with the DC connector port; and
an insulating part, partially covering the electrical connecting part, the insulating part being further provided with a slot that engages by fitting with a rim of the opening of the casing in a manner to allow a free rotation of the DC plug relative to the casing while ensuring the electrical and mechanical connection there between.

4. The power adapter of claim 3, wherein the insulating part further includes a stress-buffer structure.

5. The power adapter of claim 1, wherein the casing is formed in an approximately parallelepiped shape.

6. The power adapter of claim 1, wherein the casing is formed in an approximately parallelepiped shape and further includes at least a recessed cavity.

7. The power adapter of claim 6, wherein the DC plug freely and rotatably connects the casing within the recessed cavity.

8. The power adapter of claim 1, wherein a third terminal of the DC wire further connects an output plug.

9. The power adapter of claim 1, wherein a fourth terminal of the AC wire connects a plug.

10. A freely rotatable electrical connection structure of an electrical device, comprising:
an electrical device, having a casing in which is arranged a direct current (DC) connector port and through which is defined an opening; and
an electrical plug, including an electrical connecting part and an insulating part, the electrical connecting part rotatably mating with the DC connector port, and the insulating part further including a slot that engages by fitting with a rim of the opening of the casing in order to secure the connection between the electrical plug and the DC connector port while allowing a free rotation there between.

11. The connection structure of claim 10, wherein the insulating part further includes a stress-buffer structure.
